(19) United States
(12) Patent Application Publication
(10) Pub. No.: US 2013/0289947 A1
(43) Pub. Date: Oct. 31, 2013

(54) TEST SYSTEM AND METHOD FOR GENERATING INDUSTRIAL DESIGN OF ELECTRONIC DEVICE

(71) Applicant: SHENG-HAN LIN, Tu-Cheng (TW)

(72) Inventor: SHENG-HAN LIN, Tu-Cheng (TW)

(73) Assignee: HON HAI PRECISION INDUSTRY CO., LTD., Tu-Cheng (TW)

(21) Appl. No.: 13/563,763

(22) Filed: Aug. 1, 2012

(30) Foreign Application Priority Data
Apr. 27, 2012 (TW) 101115065

(51) Int. Cl. G06F 17/50

(52) U.S. Cl. 703/1

(57) ABSTRACT

A test system for generating an industrial design of an electronic device and a method adapted for the test system are provided. The test system firstly makes a simulation analysis for the visual features of the electronic device to obtain the frequency spectrum of vibration energy of the hard disk of the electronic device. When the frequency spectrum of vibration energy of the hard disk matches the standard frequency spectrum of vibration energy of a standard hard disk, the test system generates a prompt for making a sample of the electronic device, and the sample of the electronic device may satisfy needs of the customer or after minor amendments, thus it is no need to make a sample several times, saving time and development cost.

### BACKGROUND

1. Technical Field

The disclosure relates to test systems and, more particularly, to a test system for generating an industrial design of an electronic device and a method adapted for the test system.

2. Description of Related Art

For testing an electronic device, such as a server, test software is provided for testing a hard disk of the electronic device to obtain a test result. An industrial design of the electronic device is generated based on the test result and a sample of the electronic device is made based on the generated industrial design. As well known, an industrial design is the visual features of shape, configuration, pattern or ornament, or any combination of these features. Then the sample is compared to determine whether the sample satisfies the customer's needs, if the sample cannot satisfy the customer's needs, testers must redesign the visual features of the electronic device to generate a new industrial design and make a sample based on the new industrial design again, which results in wasting a lot of time and development cost.

Therefore, what is needed is a test system to overcome the described shortcoming.

### BRIEF DESCRIPTION OF THE DRAWINGS

FIG. 1 is a block diagram of a test system connected to an electronic device in accordance with an exemplary embodiment.

FIG. 2 is a block diagram of a processor of the test system of FIG. 1.

FIG. 3 is a flowchart of a method for generating an industrial design of the electronic device adapted for the test system of FIG. 1.

### DETAILED DESCRIPTION

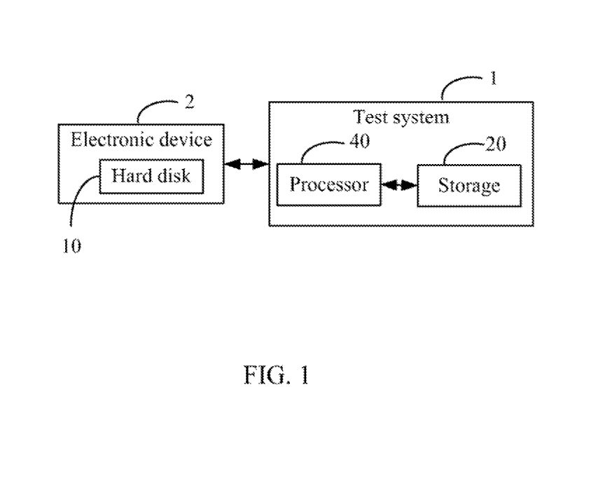

FIG. 1 is a block diagram of a test system connected to an electronic device in accordance with an exemplary embodiment. The test system 1 is utilized for testing the electronic device 2. The test system 1 is connected to the electronic device 2. The electronic device 2 includes a hard disk 10. In this embodiment, the electronic device 2 is a server. The test system 1 includes a storage 20 and a processor 40. The processor 40 controls the test system 1 to test the electronic device 2.

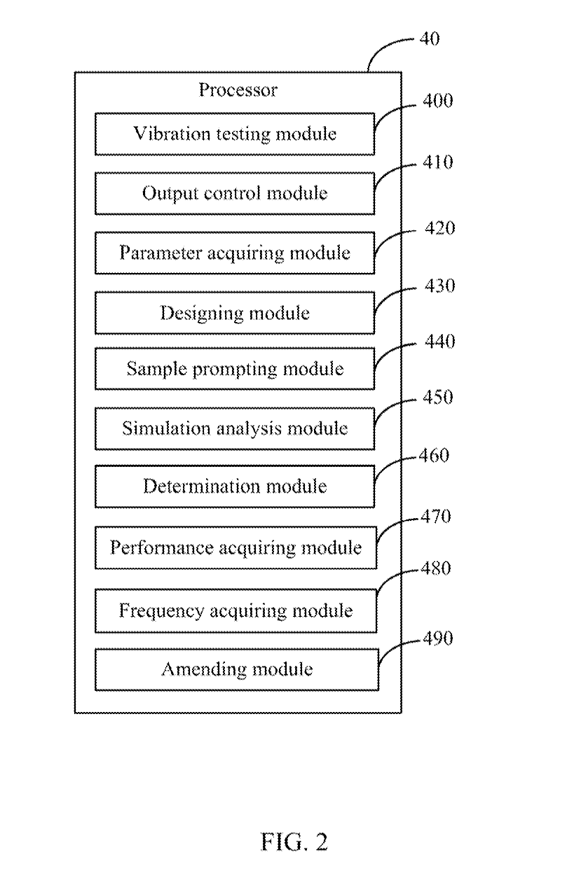

The storage 20 stores a standard frequency spectrum of vibration energy of a standard hard disk and performance requirements defined by a customer. For example, the standard frequency spectrum of vibration energy is represented by a coordinate axis which includes an X-axis and a Y-axis, and the X-axis represents frequency and the Y-axis represents vibration energy. The performance requirements are about hard disk and are represented by a number of performance parameters, such as a throughput and a value of the vibration energy. As shown in FIG. 2, the processor 40 includes an output control module 410, a designing module 430, a sample prompting module 440, a simulation analysis module 450, a determination module 460, a performance acquiring module 470, a frequency acquiring module 480, and an amending module 490.

The simulation analysis module 450 makes a finite element analysis for an industrial design the electronic device 2 and obtains a frequency spectrum of vibration energy of the hard disk 10 of the electronic device 2. For example, the finite element analysis is an implicit nonlinear nastran (MSC-Nastran) simulation analysis. The output control module 410 outputs the frequency spectrum of vibration energy of the hard disk 10. The determination module 460 determines whether the obtained frequency spectrum of vibration energy from the simulation analysis module 450 matches the standard frequency spectrum of vibration energy of the standard hard disk stored in the storage 20. For example, the determination module 460 calculates that a difference between two vibration energies of the same frequency in the obtained and the standard frequency spectrums and determines whether the difference is in a first predefined coverage scope.

If the difference between two vibration energies of each frequency in the obtained and the standard frequency spectrums is in the first predefined coverage scope, the determination module 460 determines that the obtained frequency spectrum of vibration energy from the simulation analysis module 450 matches the standard frequency spectrum of vibration energy in the storage 20. If the difference between two vibration energies of one frequency in the obtained and the standard frequency spectrums is not in the first predefined coverage scope, the determination module 460 determines that the obtained frequency spectrum of vibration energy from the simulation analysis module 450 does not match the standard frequency spectrum of vibration energy in the storage 20.

If the obtained frequency spectrum of vibration energy does not match the standard frequency spectrum of vibration energy in the storage 20, the frequency acquiring module 480 calculates that the difference between two vibration energies of the same frequency in the obtained and the standard frequency spectrums, acquires the frequency corresponding to two vibration energies whose difference is greater than a preset value, and generates a result according to the acquired frequency. The designing module 430 redesigns the visual features of the electronic device 2 based on the result generated by the frequency acquiring module 480 and generates a new industrial design of the electronic device 2. The simulation analysis module 450 makes the finite element analysis for the new industrial design of the electronic device 2 again.

If the obtained frequency spectrum of vibration energy matches the standard frequency spectrum of vibration energy in the storage 20, the sample prompting module 440 generates a prompt for making a sample of the electronic device 2. The performance acquiring module 470 does a vibration test for the hard disk 10 of the sample electronic device to acquire the performance parameters of the hard disk 10 of the sample. In the embodiment, the performance parameters of the hard disk 10 include a throughput and a value of the vibration energy.

The determination module 460 further determines whether the acquired performance parameters matches the performance requirements defined by a customer in the storage 20. For example, the determination module 460 calculates that a difference between the same performance parameter in the acquired performance parameters and the performance requirements defined by a customer and determines whether the difference is in a second predefined coverage scope.

If the difference between each performance parameter in the acquired performance parameters and the performance requirements defined by a customer is in the second predefined coverage scope, the determination module 460 determines that the acquired performance parameters match performance requirements defined by a customer in the storage 20. If the difference between a performance parameter in the acquired performance parameters and the performance requirements defined by a customer is not in the second predefined coverage scope, the determination module 460 determines that the acquired performance parameters do not match performance requirements defined by a customer in the storage 20.

If the acquired performance parameters match performance requirements defined by a customer in the storage 20, the sample prompting module 440 generates a prompt for making mass production of the sample. If the acquired performance parameters do not match performance requirements defined by a customer in the storage 20, the amending module 490 amends the visual features of the sample to the simulation analysis module 450. The simulation analysis module 450 makes a finite element analysis for the amended visual features of the electronic device 2 again. Generally, the amending module 490 amends the visual features corresponding to the performance parameter whose difference is not in the second predefined coverage scope before making the sample of the electronic device 2. Therefore, the test system 1 generates the prompt for making the sample of the electronic device 2 until the acquired performance parameters match performance requirements defined by a customer in the storage 20.

Furthermore, the storage 20 stores a vibration test program and geometrical and material parameters about hard disk. The processor 40 further includes a vibration testing module 400 and a parameter acquiring module 420. The a vibration testing module 400 acquires the vibration test program in the storage 20 and makes a vibration test for the hard disk 10 based on the vibration test program to generate a frequency spectrum of distortion force of the hard disk 10. The parameter acquiring module 420 acquires the geometrical and the material parameters about hard disk in the storage 20. The designing module 430 further designs the visual features of the electronic device 2 based on the frequency spectrum of distortion force and the geometrical and the material parameters about hard disk. The simulation analysis module 450 makes a finite element analysis for the designed visual features of the electronic device 2 again.

Therefore, the test system 1 first makes a simulation analysis for the visual features of the electronic device 2 to obtain the frequency spectrum of vibration energy of the hard disk 10 of the electronic device 2. When the frequency spectrum of vibration energy of the hard disk 10 matches the standard frequency spectrum of vibration energy of the standard hard disk, the test system 1 generates the prompt for making a sample of the electronic device 2, and the sample of the electronic device 2 may satisfy needs of the customer or after minor amendments, thus there is no need to make several samples, saving time and development cost.

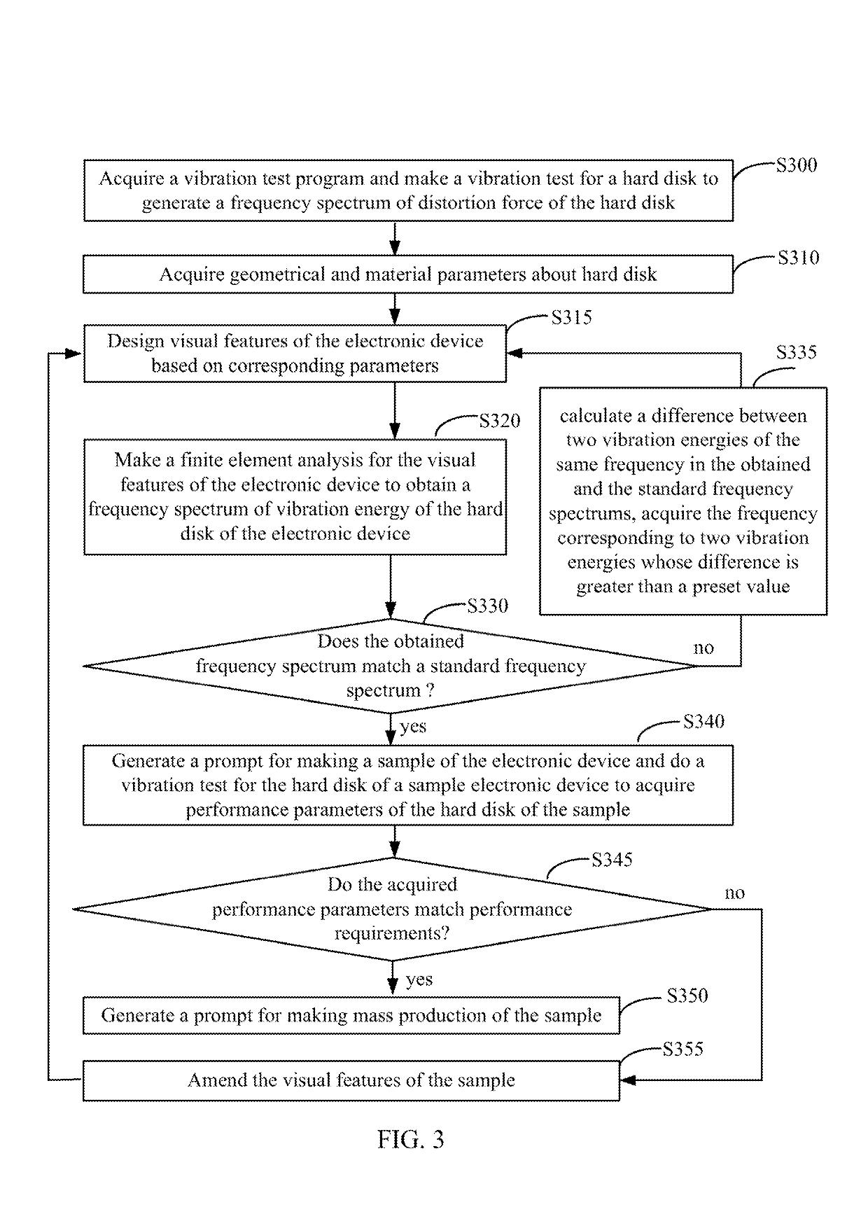

FIG. 3 is a flowchart of a method for generating an industrial design of the electronic device adapted for the test system of FIG. 1.

In step S300, the a vibration testing module 400 acquires the vibration test program in the storage 20 and makes a vibration test for the hard disk 10 based on the vibration test program to generate a frequency spectrum of distortion force of the hard disk 10. In step S310, the parameter acquiring module 420 acquires the geometrical and the material parameters about hard disk in the storage 20.

In step S315, the designing module 430 designs the visual features of the electronic device 2 based on the frequency spectrum of distortion force and the geometrical and the material parameters about hard disk. In step S320, the simulation analysis module 450 makes a finite element analysis for the visual features of the electronic device 2 and obtains a frequency spectrum of vibration energy of the hard disk 10 of the electronic device 2.

In step S330, the determination module 460 determines whether the obtained frequency spectrum of vibration energy from the simulation analysis module 450 matches the standard frequency spectrum of vibration energy in the storage 20. In step S335, if the obtained frequency spectrum of vibration energy does not match the standard frequency spectrum of vibration energy in the storage 20, the frequency acquiring module 480 calculates the difference between two vibration energies of the same frequency in the obtained and the standard frequency spectrums, acquires the frequency corresponding to two vibration energies whose difference is greater than the preset value, and generates a result according to the acquired frequency, the procedure goes back to step S315, that is, the designing module 430 redesigns the visual features of the electronic device 2 based on the result generated by the frequency acquiring module 480.

In step S340, if the obtained frequency spectrum of vibration energy matches the standard frequency spectrum of vibration energy in the storage 20, the sample prompting module 440 generates a prompt for making a sample of the electronic device 2, and the performance acquiring module 470 does a vibration test for the hard disk 10 of a sample electronic device to acquire the performance parameters of the hard disk 10 of the sample.

In step S345, the determination module 460 further determines whether the acquired performance parameters match performance requirements defined by a customer in the storage 20. In step S350, if the acquired performance parameters match performance requirements defined by a customer in the storage 20, the sample prompting module 440 generates a prompt for making mass production of the sample. In step S355, if the acquired performance parameters do not match performance requirements defined by a customer in the storage 20, the amending module 490 amends the visual features of the sample to the simulation analysis module 450, the procedure goes back to step S315, that is, the simulation analysis module 450 makes a finite element analysis for the amended visual features of the electronic device 2 again.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A test system for testing an electronic device having a hard disk, the test system comprising:
a storage to store a standard frequency spectrum of vibration energy of a standard hard disk and performance requirements, wherein the performance requirements are represented by a plurality of performance parameters; and
a processor comprising:
a simulation analysis module to make a finite element analysis for visual features of the electronic device and obtain a frequency spectrum of vibration energy of the hard disk of the electronic device;
a determination module to determine whether the obtained frequency spectrum of vibration energy matches the standard frequency spectrum of vibration energy in the storage;
a frequency acquiring module to calculate a difference between two vibration energies of the same frequency in the obtained and the standard frequency spectrums, acquire the frequency corresponding to two vibration energies whose difference is greater than a preset value, and generate a result according to the acquired frequency when the obtained frequency spectrum of vibration energy does not match the standard frequency spectrum of vibration energy in the storage;
a designing module to redesign the visual features of the electronic device based on the result generated by the frequency acquiring module and generate a new industrial design of the electronic device;
a sample prompting module to generate a prompt for making a sample of the electronic device when the obtained frequency spectrum of vibration energy matches the standard frequency spectrum of vibration energy in the storage;
a performance acquiring module to do a vibration test for the hard disk of a sample electronic device to acquire performance parameters of the hard disk of the sample, and the determination module further to determine whether the acquired performance parameters in test match performance requirements in the storage; and
an amending module to amend the visual features of the sample to the simulation analysis module when the acquired performance parameters do not match performance requirements in the storage; and the sample prompting module further to generate a prompt for making mass production of the sample when the acquired performance parameters match performance requirements in the storage.

2. The test system as recited in claim 1, wherein the plurality of performance parameters of the hard disk comprises a throughput and a value of the vibration energy.

3. The test system as recited in claim 1, wherein the finite element analysis is an implicit nonlinear Nastran simulation analysis.

4. The test system as recited in claim 1, wherein the storage is further configured to store a vibration test program and geometrical and material parameters about hard disk, the processor further comprises:
a vibration testing module to acquire the vibration test program in the storage and make a vibration test for the hard disk based on the vibration test program to generate a frequency spectrum of distortion force about hard disk;
a parameter acquiring module to acquire the geometrical and the material parameters about hard disk in the storage; and
the designing module to design the visual features of the electronic device based on the frequency spectrum of distortion force and the geometrical and the material parameters about hard disk.

5. A method for designing a structure of an electronic device for a test system, wherein the electronic device comprises a hard disk, the test system stores a standard frequency spectrum of vibration energy of a standard hard disk and performance requirements, wherein the performance requirements are represented by a plurality of performance parameters, the method comprising:
making a finite element analysis for visual features of the electronic device and obtaining a frequency spectrum of vibration energy of the hard disk of the electronic device;
determining whether the obtained frequency spectrum of vibration energy matches the standard frequency spectrum of vibration energy;
if the obtained frequency spectrum of vibration energy does not match the standard frequency spectrum of vibration energy in the storage, calculating a difference between two vibration energies of the same frequency in the obtained and the standard frequency spectrums, acquiring the frequency corresponding to two vibration energies whose difference is greater than a preset value, and generating a result according to the acquired frequency;
redesigning the visual features of the electronic device based on the result to make the finite element analysis;
if the obtained frequency spectrum of vibration energy matches the standard frequency spectrum of vibration energy, generating a prompt for making a sample of the electronic device;
doing a vibration test for the hard disk of a sample electronic device to acquire the performance parameters of the hard disk of the sample;
determining whether the acquired performance parameters in test match performance requirements;
if the acquired performance parameters do not match performance requirements in the storage, amending the visual features of the sample to make the finite element analysis; and
if the acquired performance parameters match performance requirements, generating a prompt for making mass production of the sample.

6. The method as recited in claim 5, wherein the plurality of performance parameters of the hard disk comprises a throughput and a value of the vibration energy.

7. The method as recited in claim 5, wherein the finite element analysis is an implicit nonlinear Nastran simulation analysis.

8. The method as recited in claim 5, wherein the test system further stores a vibration test program and geometrical and material parameters about hard disk, the method further comprises:
acquiring the vibration test program and making a vibration test for the hard disk based on the vibration test program to generate a frequency spectrum of distortion force about hard disk;
acquiring the geometrical and the material parameters about hard disk; and
designing the visual features of the electronic device based on the frequency spectrum of distortion force and the geometrical and the material parameters about hard disk.
